(19) United States
(12) Patent Application Publication
(10) Pub. No.: US 2015/0382016 A1
(43) Pub. Date: Dec. 31, 2015

(54) Method for Processing Multi-Component Video and Images

(71) Applicant: Mitsubishi Electric Research Laboratories, Inc., Cambridge, MA (US)

(72) Inventors: Robert Cohen, Somerville, MA (US); Xingyu Zhang, Cambridge, MA (US); Anthony Vetro, Arlington, MA (US)

(21) Appl. No.: 14/575,004

(22) Filed: Dec. 18, 2014

Related U.S. Application Data
(60) Provisional application No. 62/018,284, filed on Jun. 27, 2014.

(51) Int. Cl. H04N 19/593; H04N 19/61; H04N 19/55; H04N 19/174; H04N 19/117

(52) U.S. Cl. CPC H04N 19/593; H04N 19/174; H04N 19/117; H04N 19/55; H04N 19/61

(57) ABSTRACT

A method decodes a picture in a form of a bitstream, wherein the picture includes components, by first receiving the bitstream in a decoder. The decoder includes an intra boundary filtering process. A flag is decoded from the bitstream. Then, the intra boundary filtering process is applied, according to the flag.

### RELATED APPLICATIONS

This Non-Provisional Application claims priority to U.S. Provisional Application Ser. No. 62/018,284, “Method for Processing Multi-Component Video and Images,” filed by Cohen et al. on Jun. 27, 2014.

### FIELD OF THE INVENTION

The invention relates generally to coding pictures and videos, and more particularly to methods and decoders for predicting and filtering components in pictures in bitstreams and transforming prediction residuals the pictures and videos in the context of encoding and decoding.

### BACKGROUND OF THE INVENTION

In “HEVC Range Extensions text specification: Draft 6,” a video or sequence of pictures is compressed. Parts of this process include computing prediction residuals between a block of pixels currently being coded and previously-coded pixels. The difference between the input block of pixels and the prediction block is a prediction residual block. The prediction residual block is typically transformed, quantized, and signaled in a bitstream to be processed by a decoder.

When a picture contains multiple components, such as luminance and chrominance components or other color components, prediction can also be performed between components. For example, a prediction of a chrominance component can be computed from the luminance component, and then the difference between these two components can be signaled to represent the chrominance component.

In addition to predicting from previously-coded blocks or corresponding components of the picture, pre-computed or fixed-valued blocks can be used for prediction. Along with representations of these pixel or residual blocks, flags or indices indicating how these modes are used are signaled in a bitstream. This bitstream can be stored or transmitted for subsequent decoding.

Screen Content Coding

Two common classifications of video content are “camera-captured” and “screen content.” Camera-captured content typically contains naturally-occurring scenes as captured by a camera. Screen content typically contains computer-generated content, such as text and graphics. The statistical nature, such as correlation between pixels and presence of sharp edges or large flat areas can be quite different between camera-captured content and screen content.

Cross-Component Prediction Mode

In “HEVC Range Extensions text specification: Draft 6,” the cross-component prediction mode is used to reduce the inter-component redundancy in between prediction residuals. The decoded residue of the first color component is used to linearly predict the residue of other color components by a scaling factor. These predictions and residues are typically performed on blocks of pixels. The components can be luma, chroma, or other color components such as red, green, and blue. For convenience the first component is denoted as “luma,” and each of the other components is denoted as “chroma.” In addition to being specified in “HEVC Range Extensions text specification: Draft 6,” the cross-component prediction process is described in “JCTVC-NO266 Non RCE1: Inter Color Component Residual Prediction,” July 2013, as follows:

The chroma residual is predicted at the encoder side as:

r_{C}′(x, y)=r_{C}(x, y)−(α×r_{L}(x, y))>>3, and

the residual is compensated in the decoder as:

\hat{r}_{C}(x, y)=r_{C}′(x, y)+(α×r_{L}(x, y))>>3,

where r_{C}(x,y) denotes the residual resulting from applying intra- or inter-coded prediction modes in the chroma component at a position (x, y), and \hat{r}_{C}(x, y) denotes the residual resulting from applying cross-component prediction between scaled luma residual and chroma residual samples at position (x, y).

In the encoder, this residual can be quantized, transformed, and then signaled in the bitstream. In the decoder, this is decoded from the bitstream and then can be inverse quantized and inverse transformed; and
r_{L}(x, y) denotes the reconstructed residual resulting from applying intra- or inter-coded prediction modes in the luma component at a position (x, y); and
\hat{r}_{C}(x, y) denotes the reconstructed representation of r_{C}(x, y) in the decoder, and
   α is a scaling parameter that calculated at the encoder side and is signaled in the bitstream.

Intra Boundary Filtering

In “HEVC Range Extensions text specification: Draft 6,” when a luma block is predicted by DC mode, Horizontal mode, or Vertical mode, the predicted values of the block boundary pixels may be modified according to the reference pixels. Reference pixels are pixels located in previously-coded blocks. Note that such a filtering process is applied to luma blocks only, and not to the chroma blocks.

### SUMMARY OF THE INVENTION

Several of the sub-processes described above were developed when the main purpose of the HEVC Range Extensions activities were targeting the coding of camera-captured sequences, or when some camera-captured sequences and screen-content sequences were combined.

The cross-component prediction sub-process was developed independently from the intra boundary filtering sub-process. When coding camera-captured sequences, both of these processes improve the compression efficiency of the coding system. When coding screen content video, however, the intra boundary filtering process can decrease the coding gains obtained from the cross-component prediction process. Also, the cross-component prediction process uses a boundary-filtered luma residual block to sub-optimally predict a non-boundary-filtered chroma residual block.

There is a need, therefore, to modify either or both of the cross-component prediction and intra boundary filtering processes so that the inefficiencies introduced by both or either of these processes can be eliminated.

This invention is summarized as follows. High-level flags, e.g., sequence parameter set (SPS) flags, slice-level flags, component-level flags, picture parameter set flags, coding-tree-block flags, coding tree unit flags, and combinations thereof are encoded in the bitstream to enable or disable the intra boundary filtering process for different color components, to enable or disable the cross-component prediction process, and to enable or disable the adjustment of the cross-component prediction process to compensate for the mismatch caused when using a boundary-filtered component to predict a non-boundary-filtered component. When the intra boundary filtering process is only enabled for some, but not all of the components, an offset block can be added to the previously-processed components during the cross-component prediction process.

### BRIEF DESCRIPTION OF THE DRAWINGS

FIG. 1 is a block diagram of a decoder of a codec that uses embodiments of the invention for controlling intra boundary filtering for all components, according to embodiments of the invention;

FIG. 2 is a block diagram of a decoder of a codec that uses embodiments of the invention for controlling intra boundary filtering for components when the filtering is applied to the first component, according to embodiments of the invention;

FIG. 3 is a block diagram for applying the offset process if boundary filtering is enabled, according to embodiments of the invention; and

FIG. 4 is a block diagram of the offset process according to embodiments of the invention.

### DETAILED DESCRIPTION OF THE PREFERRED EMBODIMENTS

### Embodiment 1

In this embodiment, a high-level flag is used to indicate the presence of a low-level flag, and the low-level flag indicates whether intra boundary filtering is applied to a component in a picture in a bitstream.

Table 1 shows definitions of the flags used by embodiments of the invention.

TABLE 1

Descriptor

seq_parameter_set_rbsp( ) {
...

| | |
|---|---|
| cross_component_prediction_enabled_flag | u(1) |
| chroma_qp_adjustment_enabled_flag | u(1) |
| chroma_intra_boundary_filter_pic_enable_flag | u(1) |

slice_segment_header( ) ( ) {
...

| | |
|---|---|
| if( chroma_qp_adjustment_enabled_flag ) | |
| slice_chroma_qp_adjustment_enabled_flag | u(1) |
| If(chroma_intra_boundary_filter_pic_enable_flag) | |
| chroma_intra_boundary_filter_slice_enable_flag | u(1) |

...

Of particular interest are the following flags:

chroma_intra_boundary_filter_pic_enable_flag==1 specifies the chroma_intra_boundary_filter_slice_enable_flag is present in a slice segment header syntax, and chroma_intra_boundary_filter_pic_enable_flag==0 specifies the chroma_intra_boundary_filter_slice_enable_flag is not present in the slice segment header syntax.

When ChromaArrayType is equal to 0, it is a requirement of bitstream conformance that the chroma_intra_boundary_filter_pic_enable_flag==0.

chroma_intra_boundary_filter_slice_enable_flag equal to 1 specifies ChromalntraBoundaryFilterEnable==1.
Chroma_intra_boundary_filter_slice_enable_flag_equal to 0 specifies
ChromaIntraBoundaryFilterEnable equal to 0. When not present,
ChromaIntraBoundaryFilterEnable equal to
chroma_intra_boundary_filter_pic_enable_flag.

If cIdx or ChromalntraBoundaryFilterEnable is equal to 1, then intra boundary filtering is applied to the components, where cIdx is equal to zero for the first (luminance) component and is greater than zero for subsequent (chrominance) components.

### Embodiment 2

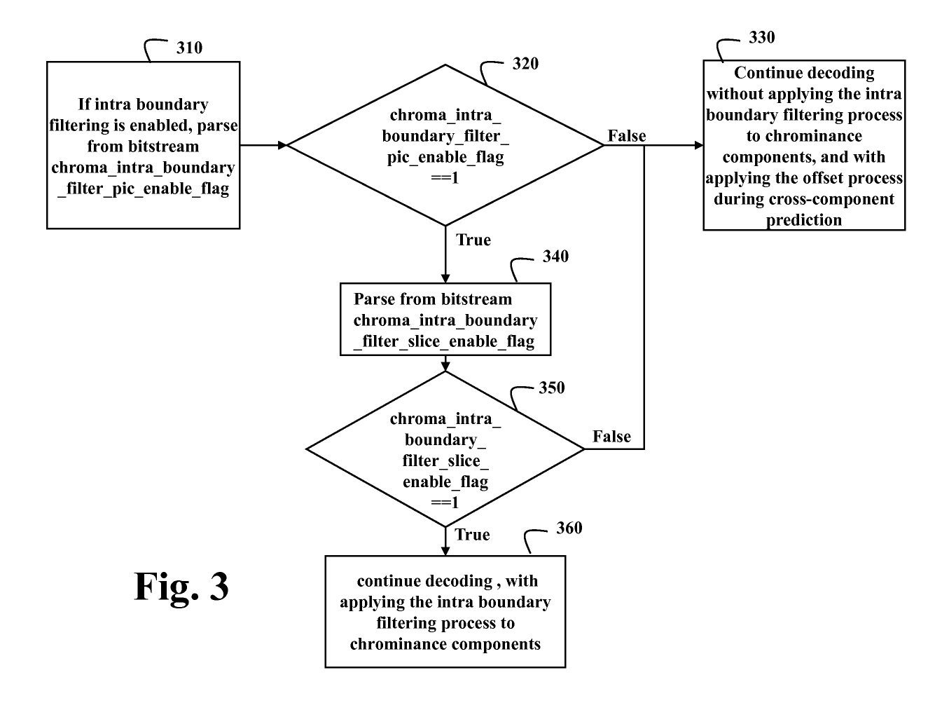

This embodiment modifies embodiment 1 by using the low-level flag to also enable or disable the application of an offset process to a component. The process for when to apply the offset process is shown in FIG. 3.

If intra boundary filtering is enabled for the first component, then a chroma_intra_boundary_filter_pic_enable_flag flag is parsed 310 from the bitstream. The value of this flag is checked 320, and if it is false, then intra boundary filtering is not applied to subsequent (chroma) components, so decoding continues 330 by applying the offset process to the subsequent components during cross-component prediction.

If chroma_intra_boundary_filter_pic_enable_flag is true, then a chroma_intra_boundary_filter_slice_enable_flag flag is parsed 340 from the bitstream.

The value of this flag is checked 350, and if chroma_intra_boundary_filter_slice_enable_flag is false, then decoding 330 continues by applying the offset process to the subsequent components during cross-component prediction.

If chroma_intra_boundary_filter_slice_enable_flag is true, then decoding 360 continues by applying the intra boundary filtering process to subsequent components.

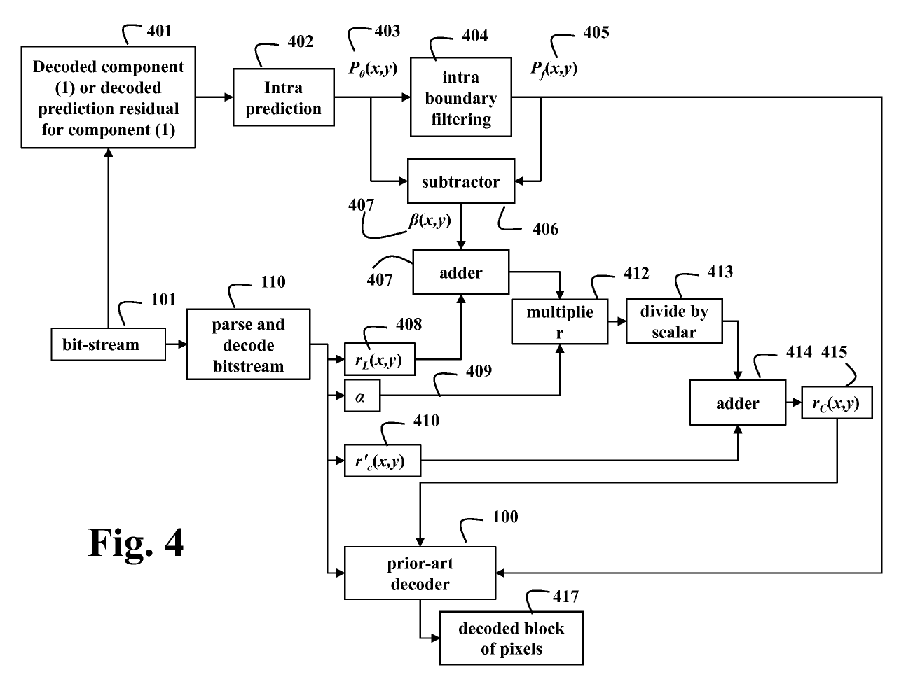

The offset process is shown in FIG. 4. The bitstream 101 is parsed and decoded 110 to produce a luminance component, a weighting factor and a chrominance prediction residual described below. A block of pixels from a first component (1) 401 is also decoded. An intra prediction process 402 is applied to the block, producing a predictor P₀(x, y) 403, where x, y denotes the location of a pixel in a two-dimensional block.

Intra boundary filtering 404 is applied to the predictor, producing a filtered predictor P_{f}(x, y) 405. The filtered predictor is subtracted 406 from the predictor, producing an offset β(x, y) 407.

The first, or luminance component r_{L}(x, y) 408, a weighting factor a 409, and a subsequent or chrominance prediction residual r′_{c}(x, y) 410 are parsed and decoded 409 from the bitstream. The offset is added 411 to the luminance component, and this sum is multiplied 412 by the weighting factor. This product is scaled 413 and is then added 414 to the chrominance prediction residual, producing a reconstructed chrominance component \hat{r}_{c}(x, y) 415, which is passed to the remainder of the processing in the conventional part of the decoder 100. The luminance component and remaining data are also parsed from the bitstream and are passed to the prior-art decoder process, which outputs a decoded block of pixels 417.

### Embodiment 3

This embodiment is a modification of Embodiment 1, in that the high-level flag and the low-level flag can be used to enable or disable the boundary filtering process for the first component, e.g., luminance, as well as the remaining components, e.g. chrominance. Examples of implementations of this process are to modify the related syntax from the earlier embodiment to remove the dependence on the component index cIdx, so that if ChromalntraBoundaryFilterEnable is equal to 1, then the intra boundary filtering is applied to the component. This modification has the effect of making chroma_intra_boundary_filter_pic_enable_flag and chroma_intra_boundary_filter_slice_enable_flag enable intra boundary filtering for all components.

### Embodiment 4

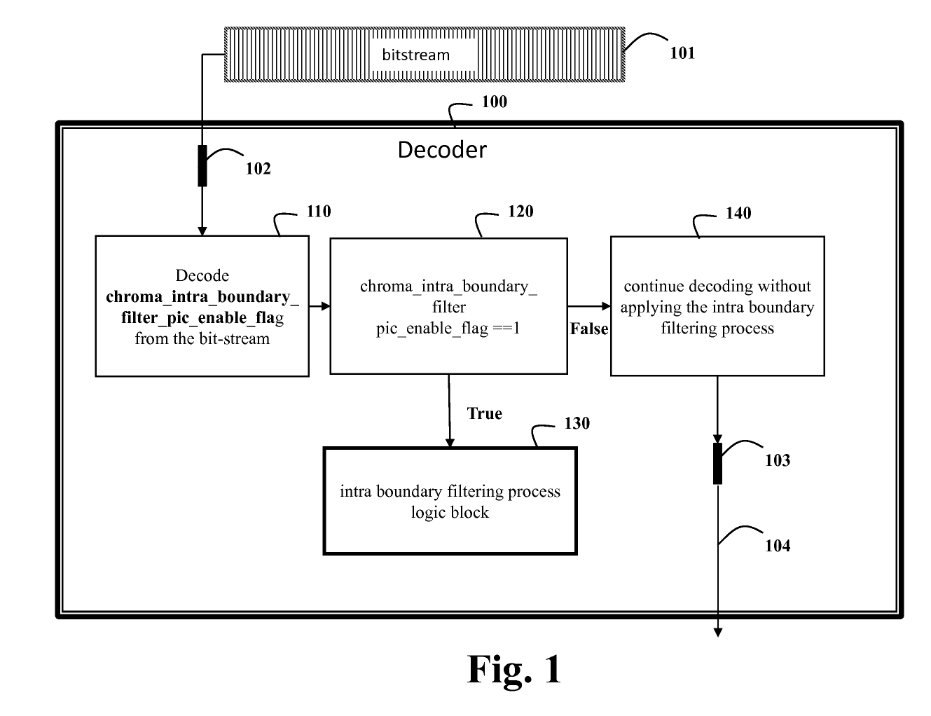

FIG. 1 shows a portion of a decoder 100 for decoding a bitstream 101 according to embodiments of the invention. Typically, the decoder is part of a codec, which performs both encoding and decoding. The decoder can be implemented using software executed in a processer connected to memory and input/output interface by busses as known in the art. Alternative, the codec can be implemented in hardware as a codec chip or chip set, or custom logic. The particular portion of the decoder of interest here performs chroma and/or luma intra boundary filtering in logic block 130. The bitstream includes a sequence of components 102, as well as various flags described herein.

As shown in FIG. 1, this embodiment modifies the earlier embodiments in that only one flag is used. For example, the chroma_boundary_filter_pic_enable_flag can be used to enable boundary filtering process for all or none of the components based on the value of the flag.

As shown in FIG. 1 for chroma filtering, the chroma_intra_boundary_filter_pic_enable_flag is decoded 110 from the bitstream. The value of this flag, e.g., 0 or 1, is checked 120, and if the flag is true (==1), then the intra boundary filtering process is applied in block 130 to the components as the components are processed by the decoder to produce decoded components 103, and ultimately a decoded bitstream 104.

If the chroma_intra_boundary_filter_pic_enable_flag is false (==0), then decoding 140 continues without applying the intra boundary filtering process to the components.

The flag can be a high-level flag, e.g., a sequence-level, to indicate that intra boundary filtering is enabled for all following components, e.g., all pictures and slices in that sequence. Each picture and slice generally has three components. Some of the other embodiments enable intra boundary filtering for each component, e.g., in a low-level slice-level flag. In those cases, the flag has an index cIdx denoting which component, e.g. flag_name[cIdx] as described in greater detail below.

### Embodiment 5

This embodiment uses a flag for each component, e.g. chroma_intra_boundary_filter_slice_enable_flag[cIdx], where cIdx indicates which component is being processes. This modification allows the boundary filtering to be enabled or disabled independently for each component of the video or image.

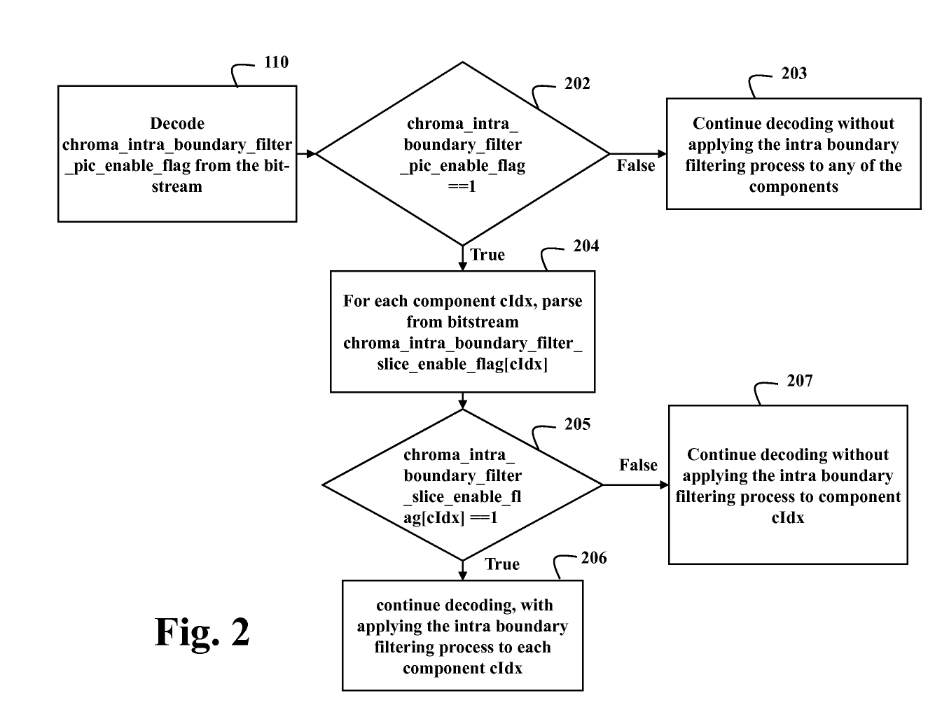

This process is shown in FIG. 2. The flag is decoded 110 from the bitstream. The value of this flag is checked 202, and if it the flag is false, then decoding 204 continues without applying an intra boundary filtering process to the components.

If chroma_intra_boundary_filter_pic_enable_flag is true, then for each component cIdx, a chroma_intra_boundary_filter_slice_enable_flag[cIdx] flag is decoded 204 from the bitstream. The chroma_intra_boundary_filter_slice_enable flag[cIdx] is checked 205, and if it is true, then decoding 206 continues with the application of the intra boundary filtering process 130 to component indexed by cIdx.

If chroma_intra_boundary_filter_slice_enable_flag[cIdx] is false, then decoding 207 continues without applying the intra boundary filtering process to component indexed by cIdx.

### Embodiment 6

This embodiment modified embodiment 4 in that the enabling flag is signaled at a picture-level, or a coding unit-level, or a transform unit-level, or at other levels lower than a slice.

### Embodiment 7

This embodiment modifies the cross_component_prediction_enabled_flag in the current standard to become cross_component_prediction_enabled_flag[cIdx], so that the cross-component prediction process can be enabled or disabled independently for each component of the video or image.

### Embodiment 8

This embodiment enables the offset process used to modify the cross-component prediction process so that if the cross_component_prediction_enabled_flag is enabled, then the offset process is applied, and if the cross_component_prediction_enabled_flag is disabled, then the offset process is not applied. This embodiment can be applied to all components or to individual components based on the flag or set of flags.

### Embodiment 9

This embodiment scales the offset values depending upon the component being processed. For example, the second component can scale the offsets by one value, and a different value can be used to scale the offsets for the next component.

### Embodiment 10

The second, third, or successive components can be used to predict the first component.

### Embodiment 11

More than one component can be used to predict another component. For example, a function of the values contained in the first and second components can be used to predict a third component.

### Embodiment 12

The cross-component prediction process and the boundary filtering process can be enabled or disabled based upon a measure of the pixel values contained in a component. For example, if the content of a block of pixels in a component have a high variance, then the prediction process for the second component can be disabled.

### Embodiment 13

The cross-component prediction process and the boundary filtering process can be enabled or disabled based upon the type of content being encoded or decoded. For example, video material captured from a camera or computer can have the above processes enabled, whereas video material captured from an infrared sensor or satellite, or related hyperspectral data, can have the above processes disabled. Moreover, the decoder and encoder can measure the incoming data to determine the correlation or other metric between components, and use thresholds on those metrics to determine whether to enable the above processes.

### Embodiment 14

The above processes are enabled or disabled partway through coding a picture, based upon previously-decoded data. If the cross-component prediction or boundary filtering processes are degrading the quality of the coded video, then one or both of these processes can be disabled for the rest of the picture.

### Embodiment 15

Analagous to the cross-component prediction enabling flags and the boundary filtering process enabling flags, another flag can be used to enable or disable the use of trType=1, or the DST-like transform, on transform units in a sequence, picture, slice, component, coding unit, prediction unit, or in other types of blocks. If the trType=1 transform is disabled, then the trType=0 transform, i.e. the DCT-like transform is applied. This enable or disable flag can apply to all intra-coded blocks, or to a subset of intra-coded blocks, such as blocks coded using the intra block copy mode.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for decoding a picture in a form of a bitstream, wherein the picture includes components, comprising steps of:
receiving the bitstream in a decoder, wherein the decoder includes an intra boundary filtering process;
decoding a flag from the bitstream; and
applying, according to the flag, the intra boundary filtering process to the components, wherein the steps are performed in a decoder.

2. The method of claim 1, wherein a slice is decoded from a bitstream, and the intra boundary filtering process is applied to the components of the slice according to the flag.

3. The method of claim 1, further comprising:
a chroma_intra_boundary_filter_pic_enable_flag is decoded from the bitstream prior to decoding the pictures, and if the chroma_intra_boundary_filter_pic_enable_flag flag is true, then for each picture a chroma_intra_boundary_filter_slice_enable_flag flag is decoded from the bitstream, otherwise a chroma_intra_boundary_filter_slice_enable_flag is not decoded from the bitstream.

4. The method of claim 1, wherein the flag is chroma_intra_boundary_filter_pic_disable_flag, and the intra boundary filtering process is applied to all components if the flag is false.

5. The method of claim 1, wherein:
each component is denoted by an index cIdx; and
for each component cIdx, a chroma_intra_boundary_filter_slice_enable_flag[cIdx] flag is decoded from the bitstream; and
the intra boundary filtering process is applied to component cIdx depending upon the value of the chroma_intra_boundary_filter_slice_enable_flag[cIdx] flag.

6. The method of claim 1, wherein the flag is signalled at a coding unit level.

7. The method of claim 1, wherein the flag is signalled at a transform unit level.

8. The method of claim 1, wherein the flag indicates whether the intra boundary filtering process is applied to the first component, and the intra boundary filtering process is not applied to the remaining components.

9. The method of claim 8, further comprising:
a cross-component prediction process is defined across the components; and
a cross_component_prediction_enabled_flag is decoded from the bitstream; and
if the intra boundary filtering process is applied to component cIdx; and
if the intra boundary filtering process is not applied to all components in the picture or slice; and
if the cross_component_prediction_enabled_flag is true; then:
for each component that has the intra boundary filtering process applied, an offset, which reverses the intra boundary filtering process, is temporarily added to the component prior to performing the cross-component prediction process.

10. The method of claim 9, wherein:
each component is denoted by an index cIdx; and
for each component cIdx, a chroma_intra_boundary_filter_slice_enable_flag[cIdx] flag is decoded from the bitstream; and
the intra boundary filtering process is applied to component cIdx depending upon the value of the chroma_intra_boundary_filter_slice_enable_flag[cIdx] flag; and
the offset is computed and temporarily added to each component for which the intra boundary filtering process was applied.

11. The method of claim 9, wherein the offset is computed for a component having cIdx greater than 0.

12. The method of claim 1, wherein:
a measure of distortion or coding cost is computed after one or more blocks in a picture are decoded; and
if the distortion or coding cost exceeds a threshold, then the intra boundary filtering process is disabled for subsequent blocks decoded from the bitstream for the picture.

13. The method of claim 1 wherein the the intra boundary filtering process is enabled based upon a measure of the pixel values contained in a component.

14. The method of claim 9 wherein the the cross-component prediction process is enabled based upon a measure of the pixel values contained in a component.

15. A decoder for decoding a picture in a form of a bitstream, wherein the picture includes components, comprising:
means for receiving the bitstream in the decoder
means for decoding a flag from the bitstream; and
an intra boundary filtering logic block configured to filter the components according to the flag.
